(19) United States
(12) Patent Application Publication
(10) Pub. No.: US 2026/0212542 A1
(43) Pub. Date: Jul. 23, 2026

(54) MODEL TRAINING METHOD, GENERATION METHOD AND APPARATUS, DEVICE, MEDIUM AND PRODUCT

(71) Applicant: Beijing Zitiao Network Technology Co., Ltd., Beijing (CN)

(72) Inventors: Tianyun ZHONG, Beijing (CN); Chao LIANG, Beijing (CN); Jianwen JIANG, Beijing (CN); Gaojie LIN, Beijing (CN); Jiaqi YANG, Beijing (CN)

(21) Appl. No.: 19/452,039

(22) Filed: Jan. 16, 2026

(30) Foreign Application Priority Data
Jan. 17, 2025 (CN) 202510081487.9

(51) Int. Cl. G06T 11/00; G06T 5/70

(52) U.S. Cl. CPC G06T 11/00; G06T 5/70; G06T 2211/441

(57) ABSTRACT

The present application discloses a model training method, a model generation method and apparatus, a device, a medium and a product. The method comprises: distilling a student model by additionally adding a plurality of learnable parameters using a trained teacher model capable of realizing multi-condition generation processing, so that the finally obtained student model may not only realize multi-condition generation processing, but also perform CFG reasoning once by way of these learnable parameters to achieve the effect presented by the teacher model through CFG reasoning for multiple times as much as possible.

### CROSS REFERENCE TO RELATED APPLICATIONS

This application is based on and claims priority of CN application with application No. 202510081487.9 filed on Jan. 17, 2025, the entire disclosure of which is incorporated herein by reference.

### TECHNICAL FIELD

The present application relates to the field of data processing technology, in particular to a model training method, a generation method and apparatus, a device, a medium and a product.

### BACKGROUND

For some scenes, such as video generation scenes, these scenes might be present with the following requirements: based on multiple conditions (for example, these two conditions of a reference image for describing a speaker+an audio for describing the speech content, or these two conditions of a reference image+a video), a generation processing is performed to obtain a generation result (for example, a new video), so that the generation result may satisfy the information described in each condition. In order to facilitate the understanding, description will be made below in conjunction with two examples.

In Example 1, after a reference image and an audio provided by the user are obtained, generation processing may be performed to obtain a new video according to the reference image and audio, so as to allow that the new video may present the speech features of the speaker described by the reference image under the audio, so that the new video may satisfy the speaker features described by the reference image and the speech content features described by the audio.

In Example 2, after a reference image and a video 1 provided by the user are provided, generation processing may be performed to obtain a video 2 according to the reference image and the video 1, so as to allow that the video 2 may present the speech features of the speaker described by the reference image under the audio carried by the video 1, so that the video 2 may satisfy the features of the speaker described by the reference image and other features described by the video 1 than the features of the speaker (for example, the speech content features), thereby replacing the speaker presented in the video 1 by the speaker described by the reference image.

### SUMMARY

In order to satisfy the above-described requirements, the present application provides a model training method, a model generation method and apparatus, a device, a medium and a product.

In order to achieve the above-described purpose, the technical solution provided by the present application is as follows:

The present application provides a model training method. The method comprises: obtaining sample data and noisy data corresponding to the sample data, wherein the sample data includes a plurality of data, and different data among the plurality of data indicate different image generation conditions; performing first processing according to a teacher model, the sample data and the noisy data to obtain a first prediction noise, and performing second processing according to a student model, the sample data and the noisy data to obtain a second prediction noise, wherein the first processing includes denoising the noisy data using a denoising net of the teacher model to obtain a plurality of noise prediction values, the different noise prediction values are obtained by introducing the different image generation conditions into the denoising net of the teacher model, and the first processing further includes fusing the plurality of noise prediction values to obtain the first prediction noise; the second processing includes introducing both the sample data and data obtained by fusing a plurality of learnable parameters into a denoising net of the student model as a condition, and the second processing also includes denoising the noisy data using the denoising net of the student model to obtain the second prediction noise, and the generation processing realized using the student model includes part or all of the second processing; and updating the student model and the plurality of learnable parameters according to a difference between the first prediction noise and the second prediction noise.

In one possible embodiment, the number of noise prediction values among the plurality of noise prediction values is determined according to the number of data among the plurality of data; and the number of learnable parameters among the plurality of learnable parameters is determined according to the number of noise prediction values among the plurality of noise prediction values.

In one possible embodiment, the plurality of data includes first data and second data; the plurality of noise prediction values include a first prediction value, a second prediction value and a third prediction value; the first prediction value is a noise prediction value obtained by not introducing any condition into the denoising net of the teacher model; the second prediction value is a noise prediction value obtained by introducing the first data into the denoising net of the teacher model as a condition; and the third prediction value is a noise prediction value obtained by introducing both the first data and the second data into the denoising net of the teacher model as a condition.

In one possible embodiment, the fusing the plurality of noise prediction values includes: performing weighted summation on a difference between the third prediction value and the second prediction value, a difference between the second prediction value and the first prediction value, and the first prediction value.

In one possible embodiment, the plurality of learnable parameters include a first parameter, a second parameter and a third parameter; the fusing the plurality of learnable parameters includes: performing weighted summation on a difference between the third parameter and the second parameter, a difference between the second parameter and the first parameter, and the first parameter.

In one possible embodiment, the plurality of noise prediction values are obtained by denoising the noisy data in a first time step sequence using the denoising net of the teacher model; and the second prediction noise is obtained by denoising the noisy data in a second time step sequence using the denoising net of the student model, and the second time step sequence is part of the first time step sequence.

In one possible embodiment, the process of determining the second time step sequence includes: splitting the first time step sequence into four sequences arranged in sequence, wherein the four sequences include a first sequence, a second sequence, a third sequence and a fourth sequence, wherein the first sequence is located at the head of the first time step sequence, and the fourth sequence is located at the tail of the first time step sequence; and determining the second time step sequence according to one time step determined from the first sequence, one time step determined from the second sequence, two time steps determined from the third sequence, and two time steps determined from the fourth sequence.

In one possible embodiment, the noisy data is obtained by adding target noise to label images corresponding to the sample data, and the label images all satisfy image generation conditions indicated by each data of the sample data; the updating the student model and the plurality of learnable parameters according to a difference between the first prediction noise and the second prediction noise includes: determining a first loss according to a difference between the first prediction noise and the second prediction noise, and determining a second loss according to a difference between the second prediction noise and the target noise; performing weighted summation on the first loss and the second loss to obtain a model loss of the student model, wherein the weight of the first loss is a preset weight value, and the weight of the second loss is determined according to a ratio between the second loss and the first loss; and updating the student model and the plurality of learnable parameters according to the model loss.

In one possible embodiment, the process of determining the weight of the second loss includes: inputting the ratio into a first function to obtain the weight of the second loss if the ratio belongs to a first interval, wherein the left end point of the first interval is zero, the right end point of the first interval is a first threshold, and the first function monotonically increases in the first interval; inputting the ratio into a second function to obtain the weight of the second loss if the ratio belongs to a second interval, wherein the left end point of the second interval is the first threshold, the right end point of the second interval is a second threshold, the second threshold is greater than the first threshold, and the second function monotonically decreases in the second interval; and determining a preset value as the weight of the second loss if the ratio is greater than or equal to the second threshold, wherein the preset value is used to indicate that the second loss does not affect the model loss.

In one possible embodiment, the process of obtaining the sample data includes: screening a plurality of high-quality data and a plurality of medium-quality data from the database according to a quality evaluation result of each data in the database, wherein each quality evaluation result of the high-quality data is higher than a first quality threshold, each quality evaluation result of the medium-quality data is lower than the first quality threshold, each quality evaluation result of the medium-quality data is higher than the second quality threshold, and the second quality threshold is lower than the first quality threshold; and determining the sample data from the plurality of high-quality data and the plurality of medium-quality data.

In one possible embodiment, the teacher model is trained using the plurality of high-quality data.

In one possible embodiment, the sample data includes a reference image, an audio segment, and at least one frame of preamble guidance image corresponding to the audio segment; the label image corresponding to the sample data includes each frame image in a video segment corresponding to the audio segment, and the video segment is used to describe an actual state of a speaker described by the reference image under the audio segment; and each of the preamble guidance images and the video segment are both determined from the same video, the arrangement position of each of the preamble guidance images in the same video is earlier than that of each frame image in the video segment in the same video, and the distance between the arrangement position of each of the preamble guidance images in the same video and the arrangement position of a first frame image in the video segment in the same video does not exceed a preset distance threshold.

The present application provides a generation method. The method comprises: obtaining target data and randomly generating noisy data, wherein the target data includes a plurality of data, and different data among the plurality of data indicate different image generation conditions; and performing generation processing according to the student model, the target data and the noisy data to obtain generation results, wherein the generation results all satisfy image generation conditions indicated by each data of the target data, and the student model is obtained using the model training method provided by the present application.

In one possible embodiment, the target data includes a reference image, a target audio segment, and at least one frame of preamble guidance image corresponding to the target audio segment, and the generation result is a video segment for describing a state of a speaker described by the reference image under the target audio segment; the at least one frame of preamble guidance image is determined from a video segment generated by processing a previous audio segment corresponding to the target audio segment using the student model; and the previous audio segment and the target audio segment are both determined from the same data, the arrangement position of the previous audio segment in the same data is adjacent to that of the target audio segment in the same data, and the arrangement position of the previous audio segment in the same data is earlier than that of the target audio segment in the same data.

The present application provides a model training apparatus. The apparatus comprises: a first obtaining unit configured to obtain sample data and noisy data corresponding to the sample data, wherein the sample data includes a plurality of data, and different data among the plurality of data indicate different image generation conditions; a first processing unit configured to perform first processing according to a teacher model, the sample data and the noisy data to obtain a first prediction noise, and perform second processing according to a student model, the sample data and the noisy data to obtain a second prediction noise, wherein the first processing includes denoising the noisy data using a denoising net of the teacher model to obtain a plurality of noise prediction values, the different noise prediction values are obtained by introducing the different image generation conditions into the denoising net of the teacher model, and the first processing further includes fusing the plurality of noise prediction values to obtain the first prediction noise; the second processing includes introducing both the sample data and data obtained by fusing a plurality of learnable parameters into a denoising net of the student model as a condition, and the second processing also includes denoising the noisy data using the denoising net of the student model to obtain the second prediction noise, and the generation processing realized using the student model includes part or all of the second processing; and a model updating unit configured to update the student model and the plurality of learnable parameters according to a difference between the first prediction noise and the second prediction noise.

The present application provides a generation apparatus. The apparatus comprises: a second obtaining unit configured to obtain target data and randomly generating noisy data, wherein the target data includes a plurality of data, and different data among the plurality of data indicate different image generation conditions; and a second processing unit configured to perform generation processing according to the student model, the target data and the noisy data to obtain generation results, wherein the generation results all satisfy image generation conditions indicated by each data of the target data, and the student model is obtained using the model training method provided by the present application.

The present application provides an electronic device. The electronic device comprises: a processor and a memory; wherein the memory is used to store instructions or computer programs; and the processor is used to execute the instructions or computer programs in the memory, so as to cause the electronic device to perform the model training method or generation method provided by the present application.

The present application provides a computer-readable medium. The computer-readable medium has instructions or computer programs stored thereon that, when running on a device, cause the device to perform the model training method or generation method provided by the present application.

The present application provides a computer program product. The computer program product includes a computer program carried on a non-transitory computer-readable medium, wherein the computer program includes program codes for performing the model training method or generation method provided by the present application.

### BRIEF DESCRIPTION OF THE DRAWINGS

In order to more explicitly explain the technical solutions in the embodiments of the present application or the relevant art, the accompanying drawings required to be used in the description of the embodiments or the relevant art will be briefly introduced below. Obviously, the accompanying drawings described below are merely some of the embodiments of the present application. For those of ordinary skill in the art, other accompanying drawings may also be obtained according to these accompanying drawings on the premise that no inventive effort is involved.

FIG. 1 is a flowchart of a model training method provided by an embodiment of the present application;

FIG. 2 is a schematic view of a distillation process provided by an embodiment of the present application;

FIG. 3 is a flowchart of a generation method provided by an embodiment of the present application;

FIG. 4 is a schematic structural view of a model training apparatus provided by an embodiment of the present application;

FIG. 5 is a schematic structural view of a generation apparatus provided by an embodiment of the present application;

FIG. 6 is a schematic structural view of an electronic device provided by an embodiment of the present application.

### DETAILED DESCRIPTION

It has been found through studies that, the above-described generation requirements may be realized by a diffusion model, such as DDPM (Denoising Diffusion Probabilistic Model) or DDIM (Denoising Diffusion Implicit Model). It may be seen that, in one possible embodiment, the multi-condition generation processing may specifically be as follows: after a plurality of conditions (for example, an image+an audio) provided by the user are obtained, the diffusion model denoises the randomly generated noisy data with reference to these conditions, so as to obtain a generation result (for example, a video) that satisfies the plurality of conditions.

It has also been found through studies that, for any diffusion model, it is necessary to perform denoising in a plurality of time steps when generation processing is realized using the diffusion model, which leads to a relatively high time overhead of the generation processing, and results in a relatively low generation efficiency.

It has also been found through studies that, in order to ensure a relatively coordinated fusion effect presented between different conditions in a final generation result, generation processing may be realized in such a manner that the diffusion model performs reasoning according to a multi-CFG manner. As an example, if the diffusion model realizes generation processing according to the time step sequence (for example, [1000, 890, . . . ]), the process of performing generation processing according to the reference image and audio includes: first of all, when denoising at each time step is realized using the denoising net of the diffusion model, denoising is performed once without introducing any condition into the denoising net, so as to obtain an unconditional processing result; denoising is performed once by introducing the image into the denoising net as a condition so as to obtain a processing result under the condition that there is an image but there is no audio; and denoising is performed once by introducing the image and the audio into the denoising net as a condition so as to obtain a processing result under the condition that there is an image and there is an audio; then, according to the CFG calculation formula shown in the following formula (1), the three processing results obtained by performing denoising processing at a time step in a final arrangement position in the time step sequence are fused to obtain a processing result with CFG control, so that a final generation result may be determined based on the processing result with CFG control subsequently.

$$D = {cfg}_{a} \times ( {d}_{a} - {d}_{r} ) + {cfg}_{r} \times ( {d}_{r} - {d}_{b} ) + {d}_{b} \qquad ( 1 )$$

In the formula, D represents the processing result with CFG control; d_{b} represents the unconditional processing result generated during the denoising process at a time step in a final arrangement position in the time step sequence; dᵣ represents the processing results under the condition that there is an image but there is no audio generated during the denoising process; da represents the processing result under the condition that there is an image and there is an audio generated during the denoising process; cfgₐ represents the classifier-free guidance intensity of the audio; cfgᵣ represents the classifier-free guidance intensity of the image. It is to be noted that, the method of obtaining these two intensities is not limited in the present application, for example, setting may be performed in advance according to actual application scenes. As another example, these two intensities may be randomly generated.

It has also been found through studies that, when multi-condition generation processing is performed using a multi-CFG method, since each time step needs to perform classifier-free guidance reasoning for multiple times, each time step needs to call the denoising net for multiple times to realize denoising under various conditions, which further increases the time overhead of the generation processing and results in a lower generation efficiency.

Based on the above-described studies, in order to better ensure that the generation time overhead is reduced as much as possible under the premise that the generation quality is not significantly reduced, the present application provides a distillation solution, which may specifically include: first obtaining sample data and noisy data corresponding to the sample data, wherein the sample data includes a plurality of data, and different data among the plurality of data indicate different image generation conditions; then performing first processing according to a teacher model, the sample data and the noisy data to obtain a first prediction noise, and performing second processing according to a student model, the sample data and the noisy data to obtain a second prediction noise, wherein the first processing includes denoising the noisy data using a denoising net of the teacher model to obtain a plurality of noise prediction values, different noise prediction values among the plurality of noise prediction values are obtained by introducing the different image generation conditions into the denoising net of the teacher model, and the first processing further includes fusing the plurality of noise prediction values to obtain the first prediction noise; the second processing includes introducing both the sample data and data obtained by fusing a plurality of learnable parameters into a denoising net of the student model as a condition, and the second processing also includes denoising the noisy data using the denoising net of the student model to obtain the second prediction noise; and finally updating the student model and the plurality of learnable parameters according to a difference between the first prediction noise and the second prediction noise.

It may be seen that, in the present application, a student model is distilled by additionally adding a plurality of learnable parameters using a trained teacher model capable of realizing multi-condition generation processing, so that the finally obtained student model may not only realize multi-condition generation processing, but also perform CFG reasoning once by way of these learnable parameters to achieve the effect presented by the teacher model through CFG reasoning for multiple times as much as possible, which may effectively overcome the defect of large time overhead when multi-condition generation processing is realized through multi-CFG reasoning, thereby facilitating reducing the generation time overhead as much as possible whilst maintaining the generation quality.

Compared with the related art, the present application has at least the following advantages:

In the technical solution provided by the present application, a student model is distilled by additionally adding a plurality of learnable parameters using a trained teacher model capable of realizing multi-condition generation processing, so that the finally obtained student model may not only realize multi-condition generation processing, but also perform CFG (Classifier-Free Guidance) reasoning once by way of these learnable parameters to achieve the effect presented by the teacher model through CFG reasoning for multiple times as much as possible, which may effectively overcome the defect of large time overhead when multi-condition generation processing is realized through multi-CFG reasoning, thereby facilitating reducing the generation time overhead as much as possible whilst maintaining the generation quality.

In order to allow those skilled in the art to better understand the solution of the present application, the technical solution in the embodiments of the present application will be explicitly and completely described below in conjunction with the accompanying drawings in the embodiments of the present application. Apparently, the described embodiments are some of the embodiments of the present application, rather than all the embodiments. On the basis of the embodiments of the present application, all the other embodiments obtained by those skilled in the art on the premise that no inventive effort is involved shall fall into the protection scope of the present application.

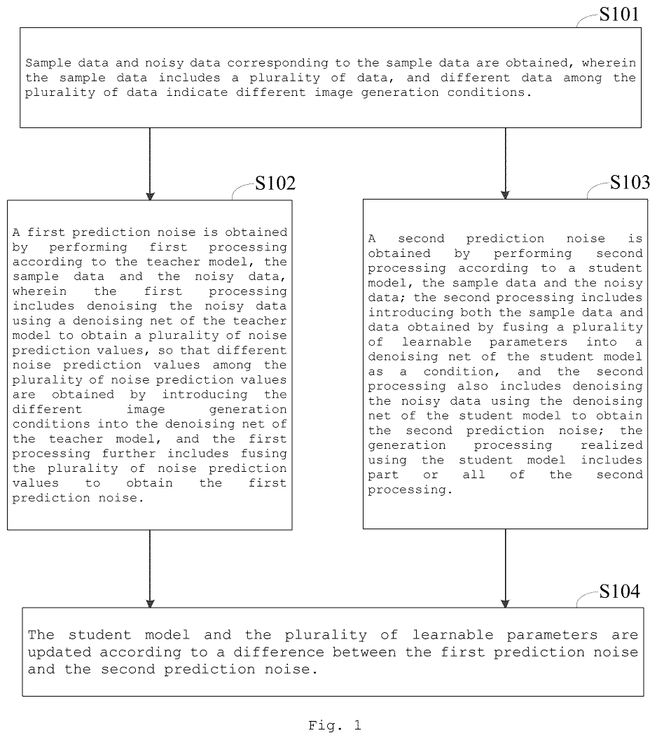

In order to better understand the technical solution provided by the present application, the model training method provided by the present application will be first explained below in conjunction with some accompanying drawings. As shown in FIG. 1, the model training method provided by the embodiment of the present application includes S101-S104 below.

In S101, sample data and noisy data corresponding to the sample data are obtained, wherein the sample data includes a plurality of data, and different data among the plurality of data indicate different image generation conditions.

Wherein, the sample data is used to serve as a reference condition required for generation processing during the distillation process, for example, a condition such as reference image+audio; and the sample data may include a plurality of data, so that different data among the plurality of data indicate different image generation conditions, so that multi-condition generation processing (for example, image generation processing or video generation processing) may be realized based on the plurality of data.

Further, the present application does not limit the implementation of the sample data. For example, in some scenes, for example, an image generation scene, the sample data may include an image for providing certain information (for example, face) and data (for example, text or image) for providing other information (for example, clothes).

For another example, in some scenes, for example, a scene where a new video is generated based on the reference image+audio, the above-described sample data may include reference image and audio, so as to generate a video with the reference image and audio as a condition subsequently, so that the video may present a state of a speaker under the audio described by the reference image, for example, a facial expression state.

It has been found through studies that, for some scenes, for example, a scene where a long video is generated based on the reference image+a long audio, in order to better improve the efficiency, the long audio may be split into a plurality of audio segments, so that generation processing of the long video may be realized by predicting a video segment generation result of each audio segment subsequently.

Based on the above-described studies, in order to better improve the time sequence consistency and the content coherence between the video segment generation results of different audio segments, for any audio segment, if the audio segment is in the first place in the long audio, the above-described sample data may include a reference image and the audio segment; however, if the audio is not in the first place in the long audio, the sample data may include a reference image, the audio segment and at least one frame of preamble guidance image corresponding to the audio segment, so that the video segment generation result of the audio segment may be predicted with the sample data as a condition subsequently. Wherein, the at least one frame of preamble guidance image is used to describe a state of a speaker described by the reference image before the state described by the video segment generation result, so that the at least one frame of preamble guidance image may provide some time sequence information for video generation processing of the audio segment.

Further, the present application does not limit the process of obtaining the above-described sample data, for example, it may specifically include: after randomly extracting a video from the database, determining a reference image from the video so that the video includes a reference image, and enabling the reference image to describe the features (for example, the image features) possessed by the speaker presented by the video so that, after randomly extracting an audio segment from the video, if the audio segment is in the first place in the video, the sample data is determined according to a reference image and the video segment so that the sample data includes a reference image and the audio segment; if the audio segment is not in the first place in the video, at least one frame of preamble guidance image corresponding to the audio segment is searched from the video, so that there is a relatively small distance between the arrangement positions of these preamble guidance images in the video and the arrangement position of the audio segment in the video, and the arrangement positions of these preamble guidance images in the video are all ahead of the arrangement position of the audio segment in the video. In this way, these preamble guidance images may provide some preamble information (for example, time sequence information) for video generation processing of the audio segment. Thus, sample data is determined according to a reference image, the audio segment and the at least one frame of preamble guidance image, so that the sample data includes a reference image, the audio segment and the at least one frame of preamble guidance image. Furthermore, a label image corresponding to the sample data may be determined according to the video segment present in the video for describing an actual state of the speaker under the audio segment, so that the label image may describe an actual state of the speaker under the audio segment described by the reference image, and the label image may all satisfy image generation conditions indicated by each data of the sample data, for example, the two conditions of the speaker image described by the reference image+the speech content described by the audio segment, so as to guide the distillation process of the student model under the sample data with the label image as the image true value subsequently.

It may be seen that, in one possible embodiment, the above sample data may at least satisfy the following constraints: the sample data includes a reference image, an audio segment, and at least one frame of preamble guidance image corresponding to the audio segment; the label image corresponding to the sample data includes each frame image in a video segment corresponding to the audio segment, and the video segment is used to describe an actual state of a speaker described by the reference image under the audio segment; and each of the preamble guidance images and the video segment are both determined from the same video, the arrangement position of each of the preamble guidance images in the same video is earlier than that of each frame image in the same video, and the distance between the arrangement position of each of the preamble guidance images in the same video and the arrangement position of a first frame image in the video segment in the same video does not exceed a preset distance threshold. Wherein, the preset distance threshold may be set according to an actual application scene.

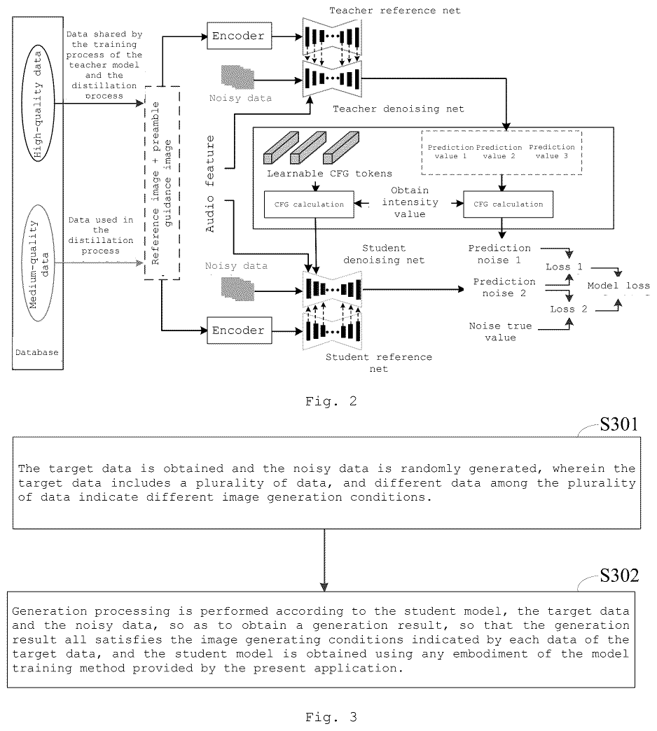

The noisy data corresponding to the sample data refers to the noisy data (the noisy data as shown in FIG. 2) that needs to be used when the student model is distilled using the sample data. Moreover, the present application does not limit the method of obtaining the noisy data. For example, the noisy data may be obtained by adding target noise to the label image corresponding to the sample data. It is to be noted that, the present application does not limit the method of adding the target noise, for example, it may be implemented by any existing or potential noise adding method used during the training process of the diffusion model.

It may be seen that, in one possible embodiment, the process of obtaining noisy data corresponding to the above-described sample data may be as follows: after a label image corresponding to the sample data is obtained, the label image is first encoded using an encoder (the encoder as shown in FIG. 2) to obtain an encoding result of the label image, so as to implement that the label image is shifted from pixel space to latent space; target noise is then added to the encoding result to obtain a noisy latent representation as noisy data corresponding to the sample data (the noisy data as shown in FIG. 2).

Based on the relevant content of S101, it may be known that for the distillation process of the current round, sample data and noisy data corresponding to the sample data are determined using a data (for example, a video) randomly extracted from the database, so that the distillation process of the current round may be realized based on these two data subsequently.

In S102, a first prediction noise is obtained by performing first processing according to the teacher model, the sample data and the noisy data, wherein the first processing includes denoising the noisy data using a denoising net of the teacher model to obtain a plurality of noise prediction values, so that different noise prediction values among the plurality of noise prediction values are obtained by introducing the different image generation conditions into the denoising net of the teacher model, and the first processing further includes fusing the plurality of noise prediction values to obtain the first prediction noise.

Wherein, the teacher model refers to a pre-trained machine learning model with a favorable multi-condition generation processing performance for providing guidance during the distillation process, for example, any diffusion model (double Unet network as shown in FIG. 2).

It may be seen that, in one possible implementation, the teacher model may include a reference net (a teacher reference net as shown in FIG. 2) and a denoising net (a teacher denoising net as shown in FIG. 2). Wherein, the reference net is used to perform feature extraction on the images (for example, a reference image in the sample data+each frame of preamble guidance image); the denoising net is used to denoise the noisy data through multi-CFG reasoning with reference to some conditions (for example, conditions such as the image features output by the reference net and the audio features obtained by feature extraction of the audio segment in the sample data). It is to be noted that, both the reference net and the denoising net are Unet networks (for example, Unet networks with the same structure), but the network parameters in the reference net are different from those in the denoising net, so that these two networks have different functions.

Further, the present application does not limit the operation principles of the teacher model, for example, it may be implemented by using the operation principles of the teacher model shown in FIG. 2.

The first processing refers to some steps that need to be performed when the noise carried by the noisy data is predicted using the teacher model, so that the generation processing realized using the teacher model includes part or all of the first processing.

The first prediction noise refers to the noise predicted when the teacher model performs multi-condition generation processing on the sample data and the noisy data, so that the first prediction noise may present the noise with CFG control predicted by the teacher model for the noisy data. In this way, the first prediction noise may present what noise the noisy data is predicted to carry. Further, the first prediction noise may present the noise predicted by the teacher model and added to the label image corresponding to the sample data, so that a generation result (for example, an image or a video segment) predicted by the teacher model for the sample data may be obtained by removing the first prediction noise from the noisy data subsequently.

Further, the present application does not limit the process of determining the first prediction noise. For example, when the sample data includes a plurality of data and different data indicates different image generation conditions, the above-described process of determining the first prediction noise may include: first, denoising the noisy data using a denoising net of the teacher model to obtain a plurality of noise prediction values (prediction value 1+prediction value 2+prediction value 3 as shown in FIG. 2), so that different noise prediction values are generated by introducing different image generation conditions (i.e., image generation conditions indicated by different data) into the denoising net of the teacher model; then, the first prediction noise with CFG control is obtained by fusing the plurality of noise prediction values (CFG calculation as shown in FIG. 2).

Wherein, the above-described plurality of noise prediction values refer to a result obtained by multi-CFG reasoning using the denoising net of the teacher model, so that the plurality of noise prediction values may present the noise predicted by introducing the different image generation conditions into the denoising net of the teacher model.

In addition, in one possible embodiment, in order to better improve the prediction effect, the number of noise prediction values among the above-described plurality of noise prediction values may be determined according to the number of data in the sample data, so that the number of noise prediction values is positively correlated with the number of data. For example, when the sample data includes N data, the plurality of noise prediction values may include N+1 noise prediction values, for example, noise prediction values obtained unconditionally, noise prediction values obtained with the first data as a condition, noise prediction values obtained with the first data+the second data as a condition, noise prediction values obtained with the first data+the second data+the third data as a condition, . . . (and so forth).

It may be seen that, in one possible embodiment, when the above-described sample data includes first data (for example, a reference image+each frame of preamble guidance image) and second data (for example, an audio segment), and the image generation conditions indicated by the first data are different from those indicated by the second data, the above-described process of determining the first prediction noise includes: first, denoising the noisy data using a denoising net of the teacher model to obtain a plurality of noise prediction values so that the plurality of noise prediction values include a first prediction value, a second prediction value and a third prediction value, wherein the first prediction value is a noise prediction value obtained by not introducing any condition into the denoising net of the teacher model; the second prediction value is a noise prediction value obtained by introducing the first data into the denoising net of the teacher model as a condition; and the third prediction value is a noise prediction value obtained by introducing both the first data and the second data into the denoising net of the teacher model as a condition; then, performing weighted summation on a difference between the third prediction value and the second prediction value, a difference between the second prediction value and the first prediction value, and the first prediction value to obtain the first prediction noise. In order to facilitate the understanding of this determining process, description will be made below in conjunction with the examples.

As an example, when the sample data includes a reference image, an audio segment and at least one frame of preamble guidance image corresponding to the audio segment, as shown in FIG. 2, the above-described process of determining the first prediction noise may include the following content:

First of all, the reference image and each frame of preamble guidance image are encoded using an encoder respectively to obtain an encoding result of the reference image and an encoding result of each frame of preamble guidance image, so that the encoding result of the reference image may better describe the information carried by the reference image and the encoding result of each frame of preamble guidance image may better describe the information carried by a corresponding preamble guidance image; and feature extraction is performed on the audio segment using a feature extractor to obtain a feature extraction result of the audio segment (the audio feature as shown in FIG. 2), so that the feature extraction result may better describe the information carried by the audio segment;

Then, the noisy data is directly denoised using the denoise net of the teacher model to obtain a prediction value 1, so as to allow that the prediction value 1 may present the noise prediction value obtained by not introducing any condition into the denoise net, so that the prediction value 1 may present an unconditional noise prediction result; the result obtained by performing feature extraction on the encoding result of the reference image and the encoding result of each frame of preamble guidance image by the reference net of the teacher model is introduced into the denoising net as a condition, so that the denoising net may denoise the noisy data based on this condition to obtain a prediction value of 2 which may present a noise prediction value obtained by introducing all images into the denoising net as a condition, so that the prediction value 2 may present a noise prediction result under the condition that there is an image but there is no audio; both the feature extraction result of the audio segment and the result obtained by performing feature extraction on the encoding result of the reference image and the encoding result of each frame of preamble guidance image by the reference net are introduced into the denoising net as a condition, so that the denoising net may denoise the noisy data based on these two conditions to obtain a prediction value of 3 which may present a noise prediction value obtained by introducing all images+audio segments into the denoising net as a condition, so that the prediction value 3 may present a noise prediction result under the condition that there is an image and there is an audio.

Finally, according to the following formula (2), the first prediction noise with CFG control (the prediction noise 1 as shown in FIG. 2) is obtained by fusing the prediction value 1, the prediction value 2 and the prediction value 3 (CFG calculation as shown in FIG. 2), so that the first prediction noise may present the noise predicted by multi-CFG reasoning using the teacher model.

$${\hat{ϵ}}_{tea} = {cfg}_{a} \times ( {\hat{ϵ}}_{a} - {\hat{ϵ}}_{r} ) + {cfg}_{r} \times ( {\hat{ϵ}}_{r} - {\hat{ϵ}}_{b} ) + {\hat{ϵ}}_{b} \qquad ( 2 )$$

In the formula, \hat{∈}ₜₑₐ represents the first prediction noise; \hat{∈}_{b} represents the prediction value 1 obtained unconditionally; \hat{∈}ᵣ represents the prediction value 2 obtained under the condition that there is an image but there is no audio; \hat{∈}ᵣ represents the prediction value 3 obtained under the condition where there is an image and there is an audio; cfgₐ represents the classifier-free guidance intensity of the audio; cfgᵣ represents the classifier-free guidance intensity of the image.

It is to be noted that, for the above encoder, the encoder is configured to encode an image. Moreover, the present application does not limit the implementation of the encoder, for example, the encoder may be implemented using an encoder in a VAE (Variational Auto Encoder). Wherein, the variational auto encoder includes an encoder (VAE Encoder) and a decoder (VAE Decoder), and the VAE Encoder is configured to compress the image from the pixel space to the latent space (also referred to as the concealed space), so that the calculation amount of a subsequent processing process is significantly reduced. The VAE Decoder is configured to convert the data in the latent space (for example, the denoised data obtained by denoising the noisy data for multiple times using the denoised network) into the pixel space to obtain a generated image. In addition, the parameters of the variational auto encoder are frozen to ensure that the parameters of the variational auto encoder are not updated during the training process and the distillation process of the teacher model. Moreover, the teacher model and the student model share the variational auto encoder.

It is also to be noted that, for the above feature extractor, the feature extractor is configured to perform feature extraction on an audio. Moreover, the present application does not limit the implementation of the feature extractor. For example, the feature extractor may be implemented using any machine learning model (for example, Wav2Vec 2.0) that may extract features from the audio. In addition, the parameters of the feature extractor are frozen to ensure that the parameters of the feature extractor are not updated during the training process and the distillation process of the teacher model. Moreover, the teacher model and the student model share the feature extractor.

It is still to be noted that, for the teacher reference net shown in FIG. 2, the teacher reference net may process the reference image and the preamble guidance frame encoded by the above encoder, and provide the appearance information of the speaker and the time sequence information of the preamble generation result for the teacher denoising net. In addition, the teacher reference net is trained during the training process of the teacher model, and the parameters are frozen during the distillation process.

It is also to be noted that, for the teacher denoising net shown in FIG. 2, the teacher denoising net may predict the noise with latent representation according to the information extracted from the above-described teacher reference net, the noisy latent representation and the audio feature information. In addition, the teacher denoising net is trained during the training process of the teacher model, and the parameters are frozen during the distillation process.

It is to be further explained that, for any denoising net, the denoising net may introduce various conditions through cross-attention. Thus, in order to better satisfy the requirements of introducing these conditions, the above-described teacher denoising net may include a spatial attention layer, a temporal attention layer and an audio attention layer. Wherein, the spatial attention layer is used to introduce an image feature extracted from the reference image through cross-attention, for example, the image feature of the speaker; the temporal attention layer is used to introduce an image feature extracted from at least one frame of preamble guidance image through cross-attention, for example, a time sequence feature between different images; the audio attention layer is used to introduce an audio feature extracted from an audio segment through cross-attention.

It may be seen that, in one possible embodiment, the construction process of the above-described teacher model is as follows: when the reference net and the denoising net of the teacher model are constructed with Stable Diffusion 1.5 as a preset structure and weight, the teacher model may be obtained by additionally adding a spatial attention layer, a temporal attention layer and an audio attention layer to the denoising net of Stable Diffusion 1.5.

Further, the present application does not limit the implementation of the “denoising the noisy data using a denoising net of the teacher model to obtain a plurality of noise prediction values” above, for example, it may specifically be: denoising the noisy data using a denoising net of the teacher model in the first time step sequence to obtain the plurality of noise prediction values. Wherein, the first time step sequence refers to the time step sequence that needs to be used when generation processing is realized using the teacher model. Moreover, the present application does not limit the first time step sequence, for example, the time step sequence may include 25 time steps arranged in sequence, for example, the sequence of [1000, 890, . . . ].

Based on the relevant content of S102 above, it may be known that, for the distillation process of the current round, after sample data and the noisy data corresponding to the sample data are obtained, the teacher model performs multi-CFG reasoning according to the sample data, so as to implement multi-condition generation processing on the noisy data to obtain the first prediction noise, so that the first prediction noise may present the noise predicted by the teacher model for the noisy data so as to measure and optimize the performance of the student model of the current round by way of the first prediction noise subsequently.

In S103, a second prediction noise is obtained by performing second processing according to a student model, the sample data and the noisy data; the second processing includes introducing both the sample data and data obtained by fusing a plurality of learnable parameters into a denoising net of the student model as a condition, and the second processing also includes denoising the noisy data using the denoising net of the student model to obtain the second prediction noise; the generation processing realized using the student model includes part or all of the second processing.

Wherein, the student model refers to the machine learning model that needs to be trained through a distillation process, for example, any diffusion model (double Unet network as shown in FIG. 2), so that the student model obtained through this distillation process may achieve the generation effect that may be presented by the trained teacher model with less time overhead.

In addition, in one possible embodiment, the structure and parameters of the student model are initialized using the structure and parameters of the trained teacher model, so that the structure of the initialized student model is the same as that of the teacher model, and the parameters of the initialized student model are the same as those of the teacher model.

It may be seen that, in one possible implementation, the student model may include a reference net (a student reference net as shown in FIG. 2) and a denoising net (a student denoising net as shown in FIG. 2). Wherein, the reference net is used to perform feature extraction on the images (for example, a reference image in the sample data+each frame of preamble guidance image); the denoising net is used to denoise the noisy data through single reasoning with reference to some conditions (for example, conditions such as the image features output by the reference net and the audio features obtained by feature extraction of the audio segment in the sample data). It is to be noted that, both the reference net and the denoising net are Unet networks (for example, Unet networks with the same structure), but the network parameters in the reference net are different from those in the denoising net, so that these two networks have different functions.

Further, the present application does not limit the operation principles of the student model, for example, it may be implemented by using the operation principles of the student model shown in FIG. 2.

The second processing refers to some steps that need to be performed when the noise carried by the noisy data is predicted using the student model, so that the generation processing realized using the student model includes part or all of the second processing.

The second prediction noise refers to the noise predicted when the student model performs multi-condition generation processing on the sample data and the noisy data, so that the second prediction noise may present the noise with CFG control predicted by the student model for the noisy data. In this way, the second prediction noise may present what noise the noisy data is predicted to carry. Further, the second prediction noise may present the noise predicted by the student model and added to the label image corresponding to the sample data, so that a generation result (for example, an image or a video segment) predicted by the student model for the sample data may be obtained by removing the second prediction noise from the noisy data subsequently.

Further, the present application does not limit the process of determining the second prediction noise. For example, when the sample data includes a plurality of data, and different data indicates different image generation conditions, the above-described process of determining the second prediction noise may include: introducing both the sample data and the data obtained by fusing a plurality of learnable parameters (CFG calculation as shown in FIG. 2) as a condition into the denoising net of the student model, and denoising the noisy data using the denoising net of the student model to obtain the second prediction noise, so as to implement accomplishing multi-condition generation processing through single CFG reasoning.

Wherein, a plurality of learnable parameters refer to tokens for simulating multi-CFG reasoning that need to be additionally learned during the distillation process, that is, learnable CFG tokens as shown in FIG. 2, so that the calculation process of fusion processing for the plurality of learnable parameters is similar to the calculation process of multi-CFG reasoning used in the teacher model. Thus, the processing process realized based on the plurality of learnable parameters may simulate the multi-classifier-free guidance reasoning process, so that it is possible to effectively ensure that the student model effectively learns the features of multi-classifier-free guidance reasoning presented in the teacher model during the distillation process by means of the plurality of learnable parameters. In this way, the result with CFG control obtained by the student model that only needs to perform single reasoning may be close to the result with CFG control obtained by the teacher model through CFG reasoning for multiple times as much as possible, so as to ensure that the effect presented by the teacher model performing reasoning for multiple times may be achieved by performing single reasoning by the student model.

It is to be noted that, the present application does not limit the implementation of the above-described plurality of learnable parameters, for example, each learnable parameter may be implemented in the form of a vector, so that the plurality of learnable parameters may include a plurality of learnable vectors.

In addition, during the CFG calculation process, the roles played by the above-described plurality of learnable parameters are the same as that played by the above-described plurality of noise prediction values, so that the number of learnable parameters among the plurality of learnable parameters may be determined according to the number of noise prediction values among the plurality of noise prediction values. For example, when the plurality of noise prediction values include N+1 noise prediction values, the plurality of learnable parameters may include N+1 learnable parameters (for example, N+1 learnable vectors), for example, an unconditional learnable parameter, a learnable parameter with the first data as a condition, a learnable parameter with the first data+the second data as a condition, and a learnable parameter with the first data+the second data+the third data as a condition, . . . (and so forth).

It may be seen that, in one possible embodiment, when the above-described sample data includes first data and second data, and the image generation conditions indicated by the first data are different from those indicated by the second data, the plurality of learnable parameters above may include a first parameter, a second parameter and a third parameter, so that the first parameter is an unconditional learnable parameter, the second parameter is a learnable parameter with the first data as a condition, and the third parameter is a learnable parameter with the first data and the second data as a condition, so as to simulate the multi-CFG fusion processing involved in the teacher model by fusing a plurality of learnable parameters (CFG calculation as shown in FIG. 2).

Further, the present application does not limit the implementation of the “fusing a plurality of learnable parameters”, for example, it may specifically be: performing weighted summation on a difference between the third parameter and the second parameter, a difference between the second parameter and the first parameter, and the first parameter.

In order to facilitate the understanding of the process of determining the second prediction noise (for example, the operation principles of the student model), description will be made below in conjunction with the examples.

As an example, when the above sample data includes a reference image, an audio segment, and at least one frame of preamble guidance image corresponding to the audio segment, and the plurality of learnable parameters include three parameters consisting of an unconditional token, a token where there is an image but there is no audio and a token where there is an image and there is an audio, as shown in FIG. 2, the above-described process of determining the second prediction noise may include the following content:

First of all, the reference image and each frame of preamble guidance image are encoded using an encoder respectively to obtain an encoding result of the reference image and an encoding result of each frame of preamble guidance image, and feature extraction is performed on the audio segment using a feature extractor to obtain a feature extraction result of the audio segment (as shown in FIG. 2).

Then, the result obtained by performing feature extraction on the encoding result of the reference image and the encoding result of each frame of preamble guidance image by the reference net of the student model, the feature extraction result of the audio segment, and the data obtained by CFG calculation on an unconditional token, a token where there is an image but there is no audio and a token where there is an image and there is an audio according to the following formula (3) are all introduced into the denoising net of the student model as a condition, so that the denoising net may denoise the noisy data under the control of these three condition information to obtain the second prediction noise with CFG control (the prediction noise 2 as shown in FIG. 2). In this way, the second prediction noise may present the noise predicted by the student model through single reasoning, so that the second prediction noise is close to the noise predicted by the teacher model through CFG reasoning for three times (the prediction noise 1 as shown in FIG. 2) as much as possible during the distillation process.

$${EMB}_{cfg} = {cfg}_{a} \times ( {γ}_{a} - {γ}_{r} ) + {cfg}_{r} \times ( {γ}_{r} - {γ}_{b} ) + {γ}_{b} \qquad ( 3 )$$

In the formula, Emb_{cfg} represents the CFG token representation, so as to introduce this Emb_{cfg} into the denoising net of the student model through cross-attention as a condition; γ_{b} represents an unconditional token; γᵣ represents a token where there is an image but there is no audio; γₐ represents a token where there is an image and there is an audio; cfgₐ represents the classifier-free guidance intensity of the audio; cfgᵣ represents the classifier-free guidance intensity of the image.

It is to be noted that, for the student reference net shown in FIG. 2, the student reference net may process the reference image and the preamble guidance frame encoded by the above-described encoder, and provide the appearance information of the speaker and the time sequence information of the preamble generation result for the student denoising net. In addition, the student reference net is trained during the distillation process.

It is also to be noted that, for the student denoising net shown in FIG. 2, the student denoising net may predict the noise with latent representation according to the information extracted from the student reference net, the noisy latent representation, the audio feature information and the CFG token representation provided in the present application.

It is still to be noted that, the above-described student denoising net includes not only a spatial attention layer, a temporal attention layer and an audio attention layer, but also a CFG control layer. Wherein, the CFG control layer is used to introduce a result obtained by CFG calculation of a plurality of learnable parameters, for example, CFG token representation, through cross-attention. In addition, in order to better improve the prediction effect, the CFG control layer is a next layer of the audio attention layer, so that the position of the CFG control layer in the network is adjacent to that of the audio attention layer in the network, and the input data of the CFG control layer includes the output data of the audio attention layer. Further, the student denoising net is trained during the distillation process, and the plurality of learnable parameters are learned during the distillation process.

It is yet to be noted that for the above fusion processing (CFG calculation as shown in FIG. 2), the weights involved in the fusion processing (for example, cfgₐ and cfgᵣ) may be fixed values set in advance according to application scenes. In addition, in order to better ensure that the student model is adapted to perform generation processing under various guidance intensities, the weights involved in the fusion processing may be randomly generated during the distillation process, so that the student model obtained through the distillation process is suitable for generation processing under any guidance intensity. In this way, the user may manually specify or select the weights according to own needs when a generation task is realized using the student model subsequently, so as to improve the generalization of the generation processing.

It is further to be noted that, the present application does not limit a relationship between the performing time of S103 and the performing time of S102, for example, they are the same. Also for example, the former is earlier than the latter. For another example, the latter is earlier than the former.

Further, the present application does not limit the implementation of the “denoising the noisy data using the denoising net of the student model to obtain the second prediction noise” above, for example, it may be specifically obtained by denoising the noisy data in the second time step sequence using the denoising net of the student model. Wherein, since the second time step sequence is part of the first time step sequence, the number of time steps in the second time step sequence is less than that in the first time step sequence used by the teacher model, and the first time step sequence includes each time step in the second time step sequence, so that the performing times of the denoising process during the generation process realized based on the second time step sequence are less than the performing times during the generation process realized based on the first time step sequence, so that it is possible to realize the object of reducing the number of time steps by way of the distillation process.

Further, the present application does not limit the above-described process of determining the second time step sequence. For example, when the distillation optimization target of the student model is determined using a piecewise rectified flow (PER flow) so as to linearize the denoising differential trajectory into four segments, so that the student model realizes generation processing using denoising processing in six time steps, the process of determining the second time step sequence may be as follows: first, the first time step sequence is split into four sequences arranged in sequence, so as to allow the four sequences include the first sequence, the second sequence, the third sequence and the fourth sequence, and the first sequence is located at the head of the first time step sequence, and the fourth sequence is located at the tail of the first time step sequence, so that the arrangement position of the first sequence in the first time step sequence is ahead of that of the second sequence in the first time step sequence, the arrangement position of the second sequence in the first time step sequence is ahead of that of the third sequence in the first time step sequence, and the arrangement position of the third sequence in the first time step sequence is ahead of that of the fourth sequence in the first time step sequence; then, the second time step sequence is determined according to one time step determined from the first sequence, one time step determined from the second sequence, two time steps determined from the third sequence, and two time steps determined from the fourth sequence, so as to allow that the second time step sequence includes these six time steps, so that the results obtained by the student model by performing denoising process under these six time steps may accurately restore the results obtained by the teacher model by performing denoising process of each time step under the first time step sequence as much as possible subsequently.

Based on the relevant content of S103 described above, it may be known that for the distillation process of the current round, after sample data and the noisy data corresponding to the sample data are obtained, the student model performs single reasoning based on the sample data to implement performing multi-condition generation processing on the noisy data to obtain the second prediction noise, so that the second prediction noise may present the noise predicted by the student model for the noisy data so as to measure the performance of the student model of the current round by way of the second prediction noise.

In S104, the student model and the plurality of learnable parameters are updated according to a difference between the first prediction noise and the second prediction noise.

It is to be noted that, the present application does not limit the implementation of S104 described above, for example, it may be implemented by any model updating method in the distillation method.

In addition, in order to better improve the distillation effect, the distillation processing for the student model may be realized by multiple rounds of iteration. Based on this, it may be known that in one possible embodiment, the above-described S104 includes: updating the student model and the plurality of learnable parameters according to a difference between the first prediction noise and the second prediction noise, and returning to continue to perform the above-described S101 and its subsequent steps until a preset stop condition is reached (for example, the condition that the model loss of the student model is lower than the preset loss threshold, the change rate of the model loss is lower than the preset change rate threshold, or the updating times of the student model reach the preset times threshold).

It is to be noted that, the model loss of the student model is configured to represent the performance of the student model. Moreover, the model loss is determined according to a difference between the first prediction noise and the second prediction noise. Further, the present application does not limit the calculation method of the model loss of the student model.

Based on the relevant content of S101 to S104 described above, it may be known that, in the model training method provided by the present application, the student model is distilled by additionally adding a plurality of learnable parameters using the trained teacher model which may realize multi-condition generation processing, so that the finally obtained student model may not only realize multi-condition generation processing, but also implement achieving the effect presented by the teacher model through CFG reasoning for multiple times as much as possible by performing CFG reasoning once by way of these learnable parameters. In this way, it is possible to effectively overcome the defect of relatively large time overhead caused when multi-condition generation processing is realized using multi-CFG reasoning, which is conductive to implement reducing the generation time overhead as much as possible on the premise that the generation quality is not significantly degraded.

Further, the present application does not limit the performing subject of the model training method, for example, the method may be applied to a terminal device or a server. For another example, the method may also be realized by way of the data interaction process between the terminal device and the server. Wherein, the terminal device may be a smart phone, a computer, a Personal Digital Assistant (PDA), a tablet computer, etc. The server may be a dedicated server, a cluster server or a cloud server.

It has been found through studies that, for the task of generation processing based on reference image+audio, in order to better perform this task, it is necessary to ensure that the machine learning model may learn the mapping between audio and image motion from a large number of data (for example, a large number of videos). In addition, in order to better improve the learning effect, some defect training data (for example, training data presenting excessive motion or training data presenting asynchronous audio) may usually be deleted from a large number of data to ensure that the remaining training data presents a high-quality, so as to ensure that the model may provide a high correlation presented between audio and image motion learned from these remaining training data. However, this strict selection process excludes a large number of data that may enhance the robustness. In addition, considering that the teacher model trained based on these remaining training data has been able to provide guidance for a relatively high correlation between audio and image motion, in order to improve the robustness, these discarded data may also be used to train the student model.

Based on the above-described studies, in order to better improve the robustness, the present application also provides one possible implementation of the “obtaining sample data” described above. In this way, the process of obtaining the sample data may include: first, screening a plurality of high-quality data and a plurality of medium-quality data from the database according to a quality evaluation result of each data in the database (the database as shown in FIG. 2), so that each quality evaluation result of the high-quality data is higher than a first quality threshold, each quality evaluation result of the medium-quality data is lower than the first quality threshold, each quality evaluation result of the medium-quality data is higher than the second quality threshold, and the second quality threshold is lower than the first quality threshold; and determining the sample data from the plurality of high-quality data and the plurality of medium-quality data. In this way, it is possible to accomplish the distillation process of a current round using the sample data, so as to achieve the object of training the student model using these high-quality data and these medium-quality data.

It is to be noted that, for any data (for example, a video) in the database, the quality evaluation result of the data is used to indicate whether there is a defect in the data, so that the result may present the quality of the data. Moreover, the present application does not limit the method of obtaining the result. For example, when the data is video, the result may be implemented by any method that may evaluate the quality of a video (for example, the method of judging whether the audio and the image are synchronized+the method of evaluating the image quality or a certain quality filtering classifier), and the present application is not limited thereto.

Based on the content of the above-described two paragraphs, it may be known that, after the database is obtained, it is possible to first perform some processing on each data in the database using a certain quality filtering classifier (for example, processing such as judging whether the audio and the image are synchronized+evaluating the image quality) to obtain a classification result of each data in the database, so that the classification result may present which category the data belongs to (for example, high-quality data, medium-quality data or low-quality data); and then determine a plurality of low-quality data, a plurality of medium-quality data and, a plurality of high-quality data from the database according to the classification results of these data, so as to directly discard these low-quality data and perform a distillation process of the student model according to these medium-quality data and these high-quality data subsequently.

It may be seen that, in one possible implementation, for a database, if the database includes a plurality of low-quality data, a plurality of medium-quality data and a plurality of high-quality data, the teacher model may be first trained using these high-quality data, so that the trained teacher model may learn a favorable generation performance (for example, high correlation between audio and image motion) from these high-quality data; and the student model is then distilled using these medium-quality data and these high-quality data to obtain a trained student model under the guidance of the teacher model, so as to improve the robustness.

It is to be noted that, the present application does not limit the process of training the teacher model. For example, for any round of training, training data and noisy data corresponding to the training data are first obtained; the training data is then denoised using the denoising net of the teacher model under a randomly selected condition (for example, unconditional conditions or a condition that there is an image but there is no audio or there is an image and there is an audio) to obtain a noise prediction result (a prediction value 1, a prediction value 2 or a prediction value 3 as shown in FIG. 2). Then, according to a difference between the noise prediction result and the noise actually carried in the noisy data, the teacher model is updated to obtain an updated teacher model, so as to allow that the updated teacher model has better performance, so that it is possible to return to continue to perform the step of “obtaining training data and noisy data corresponding to the training data” and its subsequent steps described previously based on the updated teacher model until the preset stop conditions are reached (for example, the condition that the model loss of the teacher model is lower than the preset loss threshold, the change rate of the model loss is lower than the preset change rate threshold, or the updating times of the teacher model reach the preset times threshold).

It is also to be noted that, the training data in the above paragraph is similar to the above sample data, so that the relevant content of the training data are also similar to the corresponding content of the sample data, and for the sake of conciseness, description will not be made in detail here.

It is still to be noted that, the model loss of the teacher model is configured to represent the performance of the teacher model. Moreover, the model loss is determined according to the above “difference between the noise prediction result and the noise actually carried in the noisy data”. Further, the present application does not limit the calculation method of the model loss of the student model.

It has been found through studies that, in order to better improve the distillation effect, it is possible to not only guide the training process of the student model using the teacher model, but also guide the training process of the student model using the noise true value corresponding to the sample data (for example, the above target noise). However, since the data for generating the sample data (for example, a video) might be present with a defect or not, the noise true value corresponding to the sample data might provide correct guidance or wrong guidance, thereby affecting the training effect of the student model.

Based on the above-described studies, in order to better solve the problem shown in the previous paragraph, the present application also provides one possible implementation of S104 above. In this way, when the noisy data corresponding to the sample data is obtained by adding target noise to the label image corresponding to the sample data, and the label image satisfies the image generation conditions indicated by each data of the sample data, S104 may include the following steps 11 to 13.

In Step 11, the first loss (the loss 1 as shown in FIG. 2) is determined according to a difference between the first prediction noise and the second prediction noise, and the second loss (the loss 2 as shown in FIG. 2) is determined according to a difference between the second prediction noise and the target noise.

Wherein, the first loss refers to the loss presented by the student model of the current round in the teacher model learning aspect during the distillation process, so that the first loss may present the gap between the performance of the student model of the current round and the performance of teacher model. It is to be noted that, the present application does not limit the calculation method of the first loss.

The second loss refers to the loss presented by the student model of the current round in true value learning aspect during the distillation process, so that the second loss may present the difference between the noise predicted by the student model of the current round and the true value of the noise. It is to be noted that, the present application does not limit the calculation method of the second loss.

In Step 12, weighted summation is performed on the first loss and the second loss to obtain a model loss of the student model, wherein the weight of the first loss is a preset weight value (for example, 1), and the weight of the second loss is determined according to a ratio between the second loss and the first loss.

Wherein, the weight of the first loss is used to indicate the influence degree of the teacher model on the distillation process of the current round, so that the weight may present the guidance proportion of the teacher model presented during the model updating process of the current round. Moreover, the present application does not limit the weight of the first loss, for example, the weight of the first loss may be 1. For another example, the weight of the first loss may be set according to an actual application scene.

The weight of the second loss is used to indicate the influence degree of the noise true value on the distillation process of the current round, so that the weight may present the guidance proportion of the noise true value presented during the model updating process of the current round.

In addition, the weight of the second loss may be determined according to a ratio between the second loss and the first loss, so that the weight may flexibly present the guidance proportion of the sample data with different qualities during the model updating process of the current round, so as to increase the guidance proportion of the data without a defect and reduce the guidance proportion of the data with a defect.

In addition, in order to better improve the distillation effect, as shown in the following formulas (4) to (5), the process of determining the weight of the second loss described above may include: after the ratio between the second loss and the first loss is obtained,

The ratio is input into a first function to obtain the weight of the second loss if the ratio belongs to a first interval, wherein the left end point of the first interval is zero, the right end point of the first interval is a first threshold, and the first function monotonically increases in the first interval;

The ratio is input into a second function to obtain the weight of the second loss if the ratio belongs to a second interval, wherein the left end point of the second interval is the first threshold, the right end point of the second interval is a second threshold, the second threshold is greater than the first threshold, and the second function monotonically decreases in the second interval; and

A preset value (for example, zero) is determined as the weight of the second loss if the ratio is greater than or equal to the second threshold, wherein the preset value is used to indicate that the second loss does not affect the model loss.

$$𝒲 = {𝒲}_{0} \cdot \{ \begin{matrix}{ℛ}^{s} , & ℛ < {ℛ}_{p} \\ {ℛ}_{p}^{s} ( {ℛ}_{d} - ℛ ) / ( {ℛ}_{d} - {ℛ}_{p} ) , & {ℛ}_{p} \leq ℛ < {ℛ}_{d} \\ 0 , & ℛ \geq {ℛ}_{d}\end{matrix} \qquad ( 4 )$$

$$ℛ = {L}_{GT} / {L}_{distill} \qquad ( 5 )$$

In the formula, [symbol] represents the weight of the second loss; [symbol] represents a preset value; [symbol] represents the ratio between the second loss and the first loss; L_{GT} represents the second loss; L_{distill} represents the first loss; [symbol] is the first function, so that the first function is used to indicate the calculation of the ratio to the power of s, and s represents a predetermined power number, and s>1, so that the first function is used to indicate that the weight may increase as [symbol] increases in this open interval of (0, [symbol] ), and the [symbol] represents a preset first threshold;

$${ℛ}_{p}^{s} ( {ℛ}_{d} - ℛ ) / ( {ℛ}_{d} - {ℛ}_{p} )$$

is the second function, which is used to indicate that the weight may decrease as [symbol] increases in the left-closed and right-opened interval of [ [symbol] ), and [symbol] represents a preset second threshold, and [symbol] is greater than [symbol] .

Based on the relevant content of the weight of the second loss described above, after the ratio between the second loss and the first loss is obtained, if the ratio is less than the first threshold, it may be determined that the noise true value is relatively close to the noise predicted using the teacher model, so that it may be determined that the noise true value has a relatively high credibility, and further it may be determined that the sample data is almost not present with a defect or present with less defects. Therefore, when the ratio increases in the range of 0 to the first threshold, the guidance proportion of the noise true value is increased by increasing the weight. If the ratio is not less than the first threshold but the ratio is less than the second threshold, it may be determined that the noise true value is relatively different from the noise predicted by the teacher model, so that it may be determined that the noise true value has a relatively low credibility, and further it may be determined that the sample data is present with some defects. Therefore, when the ratio increases in the range from the first threshold to the second threshold, the guidance proportion of the noise true value is reduced by reducing the weight. If the ratio is not less than the second threshold, it may be determined that the noise true value is too different from the noise predicted by the teacher model, so that it may be determined that the noise true value almost has no credibility, and further it may be determined that the sample data is present with a number of defects. Therefore, the guidance of the noise true value may be abandoned by setting the weight to 0.

Further, the present application does not limit the implementation of Step 12 above, for example, it may be implemented by the following formula (6).

$${L}_{total} = {L}_{distill} + 𝒲 \cdot {L}_{GT} \qquad ( 6 )$$

In the formula, Lₜₒₜₐₗ represents the model loss of the student model; L_{distill} represents the first loss; L_{GT} represents the second loss; [symbol] represents the weight of the second loss.

Based on the relevant content in Step 12 above, after the first loss and the second loss are obtained, the model loss of the student model may be obtained by weighted summation of these two losses, so that the model loss may present the performance of the student model. Wherein, since the weight of the second loss is determined according to a ratio between the second loss and the first loss, so that the weight of the second loss may flexibly present the guidance proportion of the sample data with different qualities to the model updating process of the current round, it is possible to effectively overcome the defects caused when model learning is guided using data with a poor quality.

In Step 13, the student model and the plurality of learnable parameters are updated according to the model loss of the student model.

It is to be noted that, the present application does not limit the implementation of the above-described step 13, for example, it may be implemented by any model updating method in the distillation method.

In addition, in order to better improve the distillation effect, the distillation processing for the student model may be realized by multiple rounds of iteration. Based on this, it may be known that, in one possible embodiment, the above-described step 13 may include: updating the student model and the plurality of learnable parameters according to the model loss of the student model, and returning to continue to perform the above-described S101 and its subsequent steps until the preset stop condition is reached.

Based on the relevant content of the above-described steps 11 to 13, the present application provides an adaptive loss mixing method, which may adaptively adjust the learning proportion of the student model from the guidance of the teacher model and the learning proportion of the student model from some previously discarded data (for example, medium-quality data), which is beneficial to improving the distillation effect.

In addition, after the student model is obtained using the above-described model training method, a generation task may be performed using the student model. Based on this, the present application also provides a generation method, and as shown in FIG. 3, the method includes the following S301 to S302.

In S301, the target data is obtained and the noisy data is randomly generated, wherein the target data includes a plurality of data, and different data among the plurality of data indicate different image generation conditions.

Wherein, the target data refers to data (for example, a reference image+audio) that may be used as a generation condition when a generation task is performed. Moreover, the target data includes a plurality of data, and different data among the plurality of data indicate different image generation conditions. It is to be noted that, the implementation of the target data is similar to that of the above sample data. It may be seen that, in one possible implementation, the target data may include a reference image and audio provided by the user.

It is to be noted that, for the noisy data in S301, the noisy data may be obtained by randomly generating the noise.

In S302, generation processing is performed according to the student model, the target data and the noisy data, so as to obtain a generation result, so that the generation result all satisfies the image generating conditions indicated by each data of the target data, and the student model is obtained using any embodiment of the model training method provided by the present application.

Wherein, the generation result refers to the result obtained when a generation task is performed using the trained student model, for example, an image, a video segment or a video.

In addition, the present application does not limit the embodiment of the above-described S302, for example, it may be specifically as follows: both the target data and the data obtained by fusing a plurality of learnable parameters (CFG calculation as shown in FIG. 2) are introduced into the denoise net of the student model as a condition, and the noisy data is denoised using the denoise net of the student model to obtain a denoise result, so that the denoise result may present the data obtained by removing the noise predicted by the denoise net from the noisy data. Then, the generation result is determined according to the denoise result (for example, the denoise result is decoded using the VAE Decoder to obtain the generation result).

Further, for a long video generation scene, the generation task may be accomplished by segmented generation, so that the video segment for describing the state of the speaker described by the reference image under each audio segment may be predicted using the student model subsequently. It is to be noted that, the generation process is similar to the generation relevant content of the video segment shown above.

It may be seen that, in one possible implementation, if the above target data may include a reference image, a target audio segment, and at least one frame of preamble guidance image corresponding to the target audio segment, the above generation result may be a video segment for describing a state of a speaker described by the reference image under the target audio segment. Wherein, the at least one frame of preamble guidance image is determined from a video segment generated by processing a previous audio segment corresponding to the target audio segment using a student model. Both the previous audio segment and the target audio segment are determined from the same data (for example, a long audio or a long video), which is an audio or a video. The arrangement position of the previous audio segment in the same data is adjacent to that of the target audio segment in the same data, and the arrangement position of the previous audio segment in the same data is ahead of that of the target audio segment in the same data.

Based on the relevant content of the above-described S301 to S302, the generation method provided by the present application comprises: after obtaining the target data (for example, a reference image+audio) provided by the user, denoising the randomly generated noisy data with the target data as a condition by the trained student model, so as to obtain a generation result (for example, a video) that may satisfy all the image generation conditions indicated by the target data. Wherein, since the student model may implement performing CFG reasoning once by way of a plurality of learnable parameters that have been learned so as to reach the effect of CFG reasoning for multiple times realized using the trained teacher model as much as possible, the generation processing realized based on the student model may reduce the generation time overhead as much as possible whilst maintaining that the generation quality is not significantly reduced, which is conducive to improving the generation effect.

Further, the present application does not limit the performing subject of the generation method, for example, the method may be applied to a terminal device or a server. For another example, the method may also be realized by the data interaction process between the terminal device and the server.

In addition, the present application does not limit the application scene of the generation method, for example, it may be applied to the video synthesis scene of the speaker. Wherein, the video synthesis of the speaker aims to make an animated video for a given image by driving a video or audio.

Based on the relevant content of the above-described model training method and generation method, it may be known that, the technical solution provided by the present application is present with the advantages shown in the following \textcircled{1} to \textcircled{4}.

\textcircled{1} In the present application, the reasoning calculation amount and the calculation time are reduced from the two aspects of reducing the number of denoising steps and reducing the classifier-free guidance calculation times using the model distillation technology on the premise of maintaining that the generation quality is not significantly reduced.

\textcircled{2} The present application provides an adaptive loss mixing method, which may adaptively adjust the learning proportion of the student model from the guidance of the teacher model and the learning proportion of the student model from some previously discarded data (for example, medium-quality data), thereby improving the robustness.

\textcircled{3} The present application solves the speed problem of multi-modal conditions during the distillation process. In the audio-driven method, the final output is realized by compound multi-classifier-free guidance reasoning. In order to make this process transparent to the student model during the training, the present application introduces a group of learnable tokens. These learnable tokens which imitate the coefficient weighting calculation of multi-classifier-free guidance, are introduced into the denoising net of the student model as control signals, so that the student model may better learn a relationship between multiple conditions, which includes a relationship arising during the reasoning process. Since the learnable token condition simulates the reasoning calculation process of multi-classifier-free guidance, the present application may reduce the times of the multi-classifier-free guidance reasoning during an actual reasoning process, thereby further reducing the reasoning time on the basis of distilling the denoising time step.

\textcircled{4} In the present application, the student model has achieved a similar level to the teacher model in terms of quantitative indicators such as image quality, audio-image synchronization and expression quality. In addition, in terms of the reasoning speed, when the student model realizes the generation processing using uses 6 time steps, but the teacher model realizes the generation processing using 25 time steps, the calling times of the denoising net in the student model is reduced to 1/12.5 of that of the teacher model.

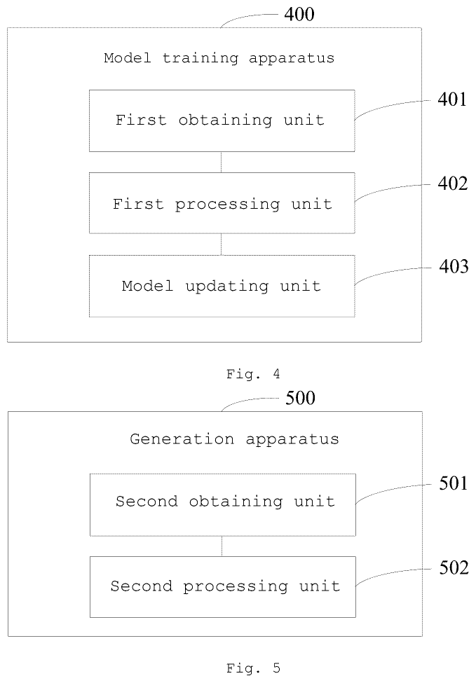

Based on the model training method provided by the embodiment of the present application, the embodiment of the present application also provides a model training apparatus, which will be interpreted and explained below in conjunction with FIG. 4. Wherein, FIG. 4 is a schematic structural view of a model training apparatus provided by an embodiment of the present application. It is to be noted that, for the technical details of the model training apparatus provided by the embodiment of the present application, please refer to the relevant content of the model training method above.

As shown in FIG. 4, the model training apparatus 400 provided by the embodiment of the present application comprises:

A first obtaining unit 401 configured to obtain sample data and noisy data corresponding to the sample data, wherein the sample data includes a plurality of data, and different data among the plurality of data indicate different image generation conditions;

A first processing unit 402 configured to perform first processing according to a teacher model, the sample data and the noisy data to obtain a first prediction noise, and perform second processing according to a student model, the sample data and the noisy data to obtain a second prediction noise, wherein the first processing includes denoising the noisy data using a denoising net of the teacher model to obtain a plurality of noise prediction values, the different noise prediction values are obtained by introducing the different image generation conditions into the denoising net of the teacher model, and the first processing further includes fusing the plurality of noise prediction values to obtain the first prediction noise; the second processing includes introducing both the sample data and data obtained by fusing a plurality of learnable parameters into a denoising net of the student model as a condition, and the second processing also includes denoising the noisy data using the denoising net of the student model to obtain the second prediction noise, and the generation processing realized using the student model includes part or all of the second processing; and

A model updating unit 403 configured to update the student model and the plurality of learnable parameters according to a difference between the first prediction noise and the second prediction noise.

In one possible embodiment, the number of noise prediction values among the plurality of noise prediction values is determined according to the number of data among the plurality of data; and the number of learnable parameters among the plurality of learnable parameters is determined according to the number of noise prediction values among the plurality of noise prediction values.

In one possible embodiment, the plurality of data includes first data and second data; the plurality of noise prediction values include a first prediction value, a second prediction value and a third prediction value; the first prediction value is a noise prediction value obtained by not introducing any condition into the denoising net of the teacher model; the second prediction value is a noise prediction value obtained by introducing the first data into the denoising net of the teacher model as a condition; and the third prediction value is a noise prediction value obtained by introducing both the first data and the second data into the denoising net of the teacher model as a condition.

In one possible embodiment, the first processing unit 402 is specifically configured to: perform weighted summation on a difference between the third prediction value and the second prediction value, a difference between the second prediction value and the first prediction value, and the first prediction value.

In one possible embodiment, the plurality of learnable parameters include a first parameter, a second parameter and a third parameter; and the first processing unit 402 is specifically configured to: perform weighted summation on a difference between the third parameter and the second parameter, a difference between the second parameter and the first parameter, and the first parameter.

In one possible embodiment, the plurality of noise prediction values are obtained by denoising the noisy data in a first time step sequence using the denoising net of the teacher model; and the second prediction noise is obtained by denoising the noisy data in a second time step sequence using the denoising net of the student model, and the second time step sequence is part of the first time step sequence.

In one possible embodiment, the process of determining the second time step sequence includes: splitting the first time step sequence into four sequences arranged in sequence, wherein the four sequences include a first sequence, a second sequence, a third sequence and a fourth sequence, wherein the first sequence is located at the head of the first time step sequence, and the fourth sequence is located at the tail of the first time step sequence; and determining the second time step sequence according to one time step determined from the first sequence, one time step determined from the second sequence, two time steps determined from the third sequence, and two time steps determined from the fourth sequence.

In one possible embodiment, the noisy data is obtained by adding target noise to label images corresponding to the sample data, and the label images all satisfy image generation conditions indicated by each data of the sample data; and the model updating model 403 is specifically configured to: determine a first loss according to a difference between the first prediction noise and the second prediction noise, and determine a second loss according to a difference between the second prediction noise and the target noise; perform weighted summation on the first loss and the second loss to obtain a model loss of the student model, wherein the weight of the first loss is a preset weight value, and the weight of the second loss is determined according to a ratio between the second loss and the first loss; and update the student model and the plurality of learnable parameters according to the model loss.

In one possible embodiment, the process of determining the weight of the second loss includes: inputting the ratio into a first function to obtain the weight of the second loss if the ratio belongs to a first interval, wherein the left end point of the first interval is zero, the right end point of the first interval is a first threshold, and the first function monotonically increases in the first interval; inputting the ratio into a second function to obtain the weight of the second loss if the ratio belongs to a second interval, wherein the left end point of the second interval is the first threshold, the right end point of the second interval is a second threshold, the second threshold is greater than the first threshold, and the second function monotonically decreases in the second interval; and determining a preset value as the weight of the second loss if the ratio is greater than or equal to the second threshold, wherein the preset value is used to indicate that the second loss does not affect the model loss.

In one possible embodiment, the first obtaining unit 401 is specifically configured to: screen a plurality of high-quality data and a plurality of medium-quality data from the database according to a quality evaluation result of each data in the database, wherein each quality evaluation result of the high-quality data is higher than a first quality threshold, each quality evaluation result of the medium-quality data is lower than the first quality threshold, each quality evaluation result of the medium-quality data is higher than the second quality threshold, and the second quality threshold is lower than the first quality threshold; and determine the sample data from the plurality of high-quality data and the plurality of medium-quality data.

In one possible embodiment, the teacher model is trained using the plurality of high-quality data.

In one possible embodiment, the sample data includes a reference image, an audio segment, and at least one frame of preamble guidance image corresponding to the audio segment; the label image corresponding to the sample data includes each frame image in a video segment corresponding to the audio segment, and the video segment is used to describe an actual state of a speaker described by the reference image under the audio segment; and each of the preamble guidance images and the video segment are both determined from the same video, the arrangement position of each of the preamble guidance images in the same video is earlier than that of each frame image in the same video, and the distance between the arrangement position of each of the preamble guidance images in the same video and the arrangement position of a first frame image in the video segment in the same video does not exceed a preset distance threshold.

On the basis of the relevant content of the above-described model training apparatus 400, it may be known that, the operation principles of the apparatus 400 comprises: distilling a student model by additionally adding a plurality of learnable parameters using a trained teacher model capable of realizing multi-condition generation processing, so that the finally obtained student model may not only realize multi-condition generation processing, but also perform CFG reasoning once by way of these learnable parameters to achieve the effect presented by the teacher model through CFG reasoning for multiple times as much as possible, which may effectively overcome the defect of large time overhead when multi-condition generation processing is realized through multi-CFG reasoning, thereby facilitating reducing the generation time overhead as much as possible whilst maintaining the generation quality.

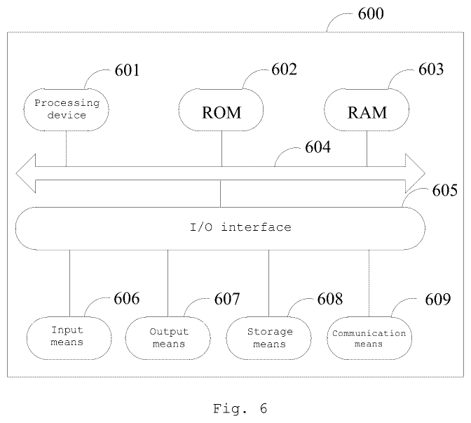

Based on the generation method provided by the embodiment of the present application, the embodiment of the present application also provides a generation apparatus, which will be interpreted and explained below in conjunction with FIG. 5. Wherein, FIG. 5 is a schematic structural view of a generation apparatus provided by an embodiment of the present application. It is to be noted that, for the technical details of the generation apparatus provided by the embodiment of the present application, please refer to the relevant content of the generation method above.

As shown in FIG. 5, the generation apparatus 500 provided by the embodiment of the present application comprises:

A second obtaining unit 501 configured to obtain target data and randomly generate noisy data, wherein the target data includes a plurality of data, and different data among the plurality of data indicate different image generation conditions; and

A second processing unit 502 configured to perform generation processing according to the student model, the target data and the noisy data to obtain generation results, wherein the generation results all satisfy image generation conditions indicated by each data of the target data, and the student model is obtained using any embodiment of the model training method provided by the present application.

In one possible embodiment, the target data includes a reference image, a target audio segment, and at least one frame of preamble guidance image corresponding to the target audio segment, and the generation result is a video segment for describing a state of a speaker described by the reference image under the target audio segment; the at least one frame of preamble guidance image is determined from a video segment generated by processing a previous audio segment corresponding to the target audio segment using the student model; and the previous audio segment and the target audio segment are both determined from the same data, the arrangement position of the previous audio segment in the same data is adjacent to that of the target audio segment in the same data, and the arrangement position of the previous audio segment in the same data is earlier than that of the target audio segment in the same data.

On the basis of the relevant content of the above-described generation apparatus 500, it may be known that, the operation principles of the apparatus 500 include: after obtaining the target data provided by the user, denoising the randomly generated noisy data with the target data as a condition by the trained student model, so as to obtain a generation result that may satisfy all the image generation conditions indicated by the target data. Wherein, since the student model may implement performing CFG reasoning once by way of a plurality of learnable parameters that have been learned so as to reach the effect of CFG reasoning for multiple times realized using the trained teacher model as much as possible, the generation processing realized based on the student model may reduce the generation time overhead as much as possible whilst maintaining that the generation quality is not significantly reduced, which is conducive to improving the generation effect.

In addition, the embodiment of the present application also provides an electronic device. The electronic device comprises: a processor and a memory; wherein the memory is used to store instructions or computer programs; and the processor is used to execute the instructions or computer programs in the memory, so as to cause the electronic device to perform any embodiment of the model training method provided by the embodiment of the present application or perform any embodiment of the generation method provided by the embodiment of the present application.

Referring to FIG. 6, it shows a schematic structural view of an electronic device 600 suitable for implementing the embodiment of the present disclosure. The terminal device in the embodiment of the present disclosure may include, but is not limited to, a mobile terminal such as a mobile phone, a notebook computer, a digital broadcast receiver, PDA (Personal Digital Assistant), PAD (Pad Computer), PMP (Portable Multimedia Player) and a vehicle-mounted terminal (for example, a vehicle-mounted navigation terminal); and a fixed terminal such as digital TV and a desktop computer. The electronic device shown in FIG. 6 which is only an example, shall not limit the functions and application range of the embodiments of the present disclosure.

As shown in FIG. 6, the electronic device 600 may include a processing device (for example, a central processing unit, a graphic processor, and the like) 601, which may perform various suitable actions and processing according to a program stored in a Read-only Memory (ROM) 602 or a program loaded from a storage device 608 into a Random Access Memory (RAM) 603. In the RAM 603, various programs and data required for the operation of the electronic device 600 are also stored. The processing device 601, the ROM 602 and the RAM 603 are connected to each other through a bus 604. The input/output (I/O) interface 605 is also connected to the bus 604.

Generally, the following devices may be connected to the I/O interface 605: an input means 606 including, for example, a touch screen, a touch pad, a keyboard, a mouse, a camera, a microphone, an accelerometer, a gyroscope, and the like; an output means 607 including, for example, a Liquid Crystal Display (LCD), a speaker, a vibrator, and the like; a storage means 608 including, for example, a magnetic tape, a hard disk, and the like; and a communication means 609. The communication means 609 may allow the electronic means 600 to be in wireless or wired communication with other devices to exchange data. Although FIG. 6 shows the electronic device 600 with various devices, it should be understood that it is not required to implement or possess all the devices shown. It is possible to alternatively implement or possess more or less devices.

In particular, according to the embodiment of the present disclosure, the process described above with reference to the flowchart may be implemented as a computer software program. For example, an embodiment of the present disclosure includes a computer program product, which includes a computer program carried on a non-transient computer-readable medium, wherein the computer program contains program codes for performing the method shown in the flowchart. In such embodiment, the computer program may be downloaded and installed from the network through the communication means 609, installed from the storage means 608, or installed from the ROM 602. When the computer program is executed by the processing device 601, the above-described functions defined in the method of the embodiment of the present disclosure are performed.

The electronic device provided by the embodiment of the present disclosure pertains to the same inventive concept as the method provided by the above-described embodiments, and reference may be made to the above-described embodiments for the technical details that have not been elaborated, and this embodiment has the same beneficial effects as the above-described embodiments.

The embodiment of the present application also provides a computer-readable medium, having instructions or computer programs stored thereon that, when run on a device, cause the device to perform any embodiment of the model training method provided by the embodiment of the present application or perform any embodiment of the generation method provided by the embodiment of the present application.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may include, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program which may be used by an instruction execution system, apparatus, or device or used in combination therewith. In the present disclosure, the computer-readable signal medium may include a data signal propagated in a baseband or as a part of a carrier wave, wherein a computer-readable program code is carried. This propagated data signal may use multiple forms, including but not limited to electromagnetic signals, optical signals or any suitable combination thereof. The computer-readable signal medium may also be any computer-readable medium other than a computer-readable storage medium, which may send, propagate or transmit a program for use by or in connection with an instruction execution system, apparatus or device. The program code contained on the computer-readable medium may be transmitted by any suitable medium, including but not limited to: a wire, an optical cable, radio frequency (RF), and the like, or any suitable combination thereof.

In some embodiments, the client and the server may communicate using any currently known or future developed network protocol such as HTTP (Hyper Text Transfer Protocol), and may be interconnected with digital data communication in any form or medium (for example, communication network). Examples of communication networks include a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be included in the above-described electronic device; or may also exist alone without being assembled into the electronic device.

The above-described computer-readable medium carries one or more programs that, when executed by the electronic device, cause the electronic device to perform the above-described method.

The computer program code for performing the operations of the present disclosure may be written in one or more programming languages or a combination thereof. The above-described programming languages include but are not limited to object-oriented programming languages, such as Java, Smalltalk, and C++, and also include conventional procedural programming languages, such as “C” language or similar programming languages. The program code may be executed entirely on the user computer, partly on the user computer, executed as an independent software package, partly on the user computer and partly executed on a remote computer, or entirely executed on the remote computer or server. In the case of a remote computer, the remote computer may be connected to the user computer through any kind of network (including a local area network (LAN) or a wide area network (WAN)), or may be connected to an external computer (for example, connected through Internet using an Internet service provider).

The flowcharts and block diagrams in the accompanying drawings illustrate the possibly implemented architectures, functions, and operations of the system, method, and computer program product according to various embodiments of the present disclosure. In this regard, each block in the flowchart or block diagram may represent a module, a program segment, or a part of code, wherein the module, the program segment, or the part of code contains one or more executable instructions for realizing a specified logic function. It should also be noted that, in some implementations as an alternative, the functions marked in the block may also occur in a sequence different from that marked in the accompanying drawings. For example, two blocks shown in succession which may actually be executed substantially in parallel, may sometimes also be executed in a reverse order, depending on the functions involved. It is also to be noted that, each block in the block diagram and/or flowchart, and a combination of blocks in the block diagram and/or flowchart, may be implemented by a dedicated hardware-based system that performs specified functions or operations, or may be implemented by a combination of dedicated hardware and computer instructions.

The units involved in the described embodiments of the present disclosure may be implemented in software or hardware. Wherein, the names of the units/modules do not constitute a limitation on the units themselves under a certain circumstance.

The functions described above herein may be performed at least in part by one or more hardware logic components. For example, non-restrictively, the hardware logic components of a demonstrative type that may be used include: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, the machine-readable medium may be a tangible medium that may contain or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

It is to be noted that, each embodiment in this specification is described in a progressive way, and each embodiment focuses on the differences from other embodiments, so the same and similar parts among each embodiment can be referred to each other. As for the system or device disclosed in the embodiment, since it corresponds to the method disclosed in the embodiment, the description is relatively simple, so that the related parts can be referred to the description of the method part.

It should be understood that, in the present application, “at least one (item)” means one or more, and “a plurality of” means two or more. “and/or” is used to describe an associated relationship between associated objects, indicating that there may be three relationships. For example, “A and/or B” may present that there are three circumstances of only A, only B and A and B at the same time, where A and B may be singular or plural. The character “/” generally presents that the contextually associated objects are in an “or” relationship. “At least one of the following (items)” or its similar expression refers to any combination of these items, including any combination of single (item) or plural (items). For example, at least one (item) of a, b or c may present: a, b, c, “a and b”, “a and c”, “b and c”, or “a and b and c”, where a, b and c may be single or multiple.

It is also to be noted that, the relational terms such as “first” and “second” herein are only used to distinguish one entity or operation from another entity or operation, but do not necessarily require or imply that there is any such actual relationship or order between these entities or operations. Moreover, the terms “comprising”, “including” or any other variation thereof are intended to cover non-exclusive inclusions, so that a process, method, article or device including a series of elements includes not only those elements, but also other elements not explicitly listed or elements inherent to such process, method, article or device. Without further restrictions, an element defined by the phrase “including one . . . ” does not exclude the existence of other identical elements in the process, method, article or device including the element.

The steps of a method or algorithm described in conjunction with the embodiments disclosed herein may be directly implemented in hardware, a software module executed by a processor, or a combination thereof. The software module may be placed in a random access memory (RAM), an internal memory, a read-only memory (ROM), an electrically programmable ROM, an electrically erasable programmable ROM, a register, a hard disk, a removable disk, CD-ROM, or any other form of storage medium known in the technical field.

The above-described description of the disclosed embodiments enables those skilled in the art to realize or use the present application. Multiple modifications to these embodiments will be obvious for those skilled in the art, and the general principles defined herein may be realized in other embodiments without departing from the spirit or scope of the present application. Therefore, the present application will not be limited to these embodiments shown herein, but intended to conform to the broadest scope consistent with the principles and novel features disclosed herein.

What is claimed is:

1. A model training method, comprising:
obtaining sample data and noisy data corresponding to the sample data, wherein the sample data comprises a plurality of data, and different data among the plurality of data indicate different image generation conditions;
performing first processing according to a teacher model, the sample data and the noisy data to obtain a first prediction noise, and performing second processing according to a student model, the sample data and the noisy data to obtain a second prediction noise, wherein the first processing comprises denoising the noisy data using a denoising net of the teacher model to obtain a plurality of noise prediction values, different noise prediction values are obtained by introducing the different image generation conditions into the denoising net of the teacher model, and the first processing further comprises fusing the plurality of noise prediction values to obtain the first prediction noise; the second processing comprises introducing both the sample data and data obtained by fusing a plurality of learnable parameters into a denoising net of the student model as a condition, and the second processing also comprises denoising the noisy data using the denoising net of the student model to obtain the second prediction noise, and generation processing realized using the student model comprises part or all of the second processing; and
updating the student model and the plurality of learnable parameters according to a difference between the first prediction noise and the second prediction noise.

2. The method according to claim 1, wherein a number of noise prediction values among the plurality of noise prediction values is determined according to a number of data among the plurality of data; and
a number of learnable parameters among the plurality of learnable parameters is determined according to the number of noise prediction values among the plurality of noise prediction values.

3. The method according to claim 1, wherein the plurality of data comprises first data and second data;
the plurality of noise prediction values comprise a first prediction value, a second prediction value and a third prediction value;
the first prediction value is a noise prediction value obtained by not introducing any condition into the denoising net of the teacher model;
the second prediction value is a noise prediction value obtained by introducing the first data into the denoising net of the teacher model as a condition; and
the third prediction value is a noise prediction value obtained by introducing both the first data and the second data into the denoising net of the teacher model as a condition.

4. The method according to claim 3, wherein the fusing the plurality of noise prediction values comprises:
performing weighted summation on a difference between the third prediction value and the second prediction value, a difference between the second prediction value and the first prediction value, and the first prediction value.

5. The method according to claim 4, wherein the plurality of learnable parameters comprise a first parameter, a second parameter and a third parameter;
the fusing the plurality of learnable parameters comprises:
performing weighted summation on a difference between the third parameter and the second parameter, a difference between the second parameter and the first parameter, and the first parameter.

6. The method according to claim 1, wherein the plurality of noise prediction values are obtained by denoising the noisy data in a first time step sequence using the denoising net of the teacher model; and
the second prediction noise is obtained by denoising the noisy data in a second time step sequence using the denoising net of the student model, and the second time step sequence is part of the first time step sequence.

7. The method according to claim 6, wherein a process of determining the second time step sequence comprises:
splitting the first time step sequence into four sequences arranged in sequence, wherein the four sequences comprise a first sequence, a second sequence, a third sequence and a fourth sequence, wherein the first sequence is located at a head of the first time step sequence, and the fourth sequence is located at a tail of the first time step sequence; and
determining the second time step sequence according to one time step determined from the first sequence, one time step determined from the second sequence, two time steps determined from the third sequence, and two time steps determined from the fourth sequence.

8. The method according to claim 1, wherein the noisy data is obtained by adding target noise to label images corresponding to the sample data, and the label images all satisfy image generation conditions indicated by each data of the sample data;
the updating the student model and the plurality of learnable parameters according to a difference between the first prediction noise and the second prediction noise comprises:
determining a first loss according to a difference between the first prediction noise and the second prediction noise, and determining a second loss according to a difference between the second prediction noise and the target noise;
performing weighted summation on the first loss and the second loss to obtain a model loss of the student model, wherein the weight of the first loss is a preset weight value, and the weight of the second loss is determined according to a ratio between the second loss and the first loss; and
updating the student model and the plurality of learnable parameters according to the model loss.

9. The method according to claim 8, wherein a process of determining the weight of the second loss comprises:
inputting the ratio into a first function to obtain the weight of the second loss if the ratio belongs to a first interval, wherein the left end point of the first interval is zero, the right end point of the first interval is a first threshold, and the first function monotonically increases in the first interval;
inputting the ratio into a second function to obtain the weight of the second loss if the ratio belongs to a second interval, wherein the left end point of the second interval is the first threshold, the right end point of the second interval is a second threshold, the second threshold is greater than the first threshold, and the second function monotonically decreases in the second interval; and
determining a preset value as the weight of the second loss if the ratio is greater than or equal to the second threshold, wherein the preset value is used to indicate that the second loss does not affect the model loss.

10. The method according to claim 1, wherein a process of obtaining the sample data comprises:
screening a plurality of high-quality data and a plurality of medium-quality data from the database according to a quality evaluation result of each data in the database, wherein each quality evaluation result of the high-quality data is higher than a first quality threshold, each quality evaluation result of the medium-quality data is lower than the first quality threshold, each quality evaluation result of the medium-quality data is higher than the second quality threshold, and the second quality threshold is lower than the first quality threshold; and
determining the sample data from the plurality of high-quality data and the plurality of medium-quality data.

11. The method according to claim 10, wherein the teacher model is trained using the plurality of high-quality data.

12. The method according to claim 1, wherein the sample data comprises a reference image, an audio segment, and at least one frame of preamble guidance image corresponding to the audio segment;
the label image corresponding to the sample data comprises each frame image in a video segment corresponding to the audio segment, and the video segment is used to describe an actual state of a speaker described by the reference image under the audio segment; and
each of the preamble guidance images and the video segment are both determined from a same video, an arrangement position of each of the preamble guidance images in the same video is earlier than that of each frame image in the same video, and a distance between the arrangement position of each of the preamble guidance images in the same video and the arrangement position of a first frame image in the video segment in the same video does not exceed a preset distance threshold.

13. A generation method, comprising:
obtaining target data and randomly generating noisy data, wherein the target data comprises a plurality of data, and different data among the plurality of data indicate different image generation conditions; and
performing generation processing according to the student model, the target data and the noisy data to obtain generation results, wherein the generation results all satisfy image generation conditions indicated by each data of the target data, and the student model is obtained using a model training method comprising:
obtaining sample data and noisy data corresponding to the sample data, wherein the sample data comprises a plurality of data, and different data among the plurality of data indicate different image generation conditions;
performing first processing according to a teacher model, the sample data and the noisy data to obtain a first prediction noise, and performing second processing according to a student model, the sample data and the noisy data to obtain a second prediction noise, wherein the first processing comprises denoising the noisy data using a denoising net of the teacher model to obtain a plurality of noise prediction values, different noise prediction values are obtained by introducing the different image generation conditions into the denoising net of the teacher model, and the first processing further comprises fusing the plurality of noise prediction values to obtain the first prediction noise; the second processing comprises introducing both the sample data and data obtained by fusing a plurality of learnable parameters into a denoising net of the student model as a condition, and the second processing also comprises denoising the noisy data using the denoising net of the student model to obtain the second prediction noise, and generation processing realized using the student model comprises part or all of the second processing; and
updating the student model and the plurality of learnable parameters according to a difference between the first prediction noise and the second prediction noise.

14. The method according to claim 13, wherein the target data comprises a reference image, a target audio segment, and at least one frame of preamble guidance image corresponding to the target audio segment, and the generation result is a video segment for describing a state of a speaker described by the reference image under the target audio segment;
the at least one frame of preamble guidance image is determined from a video segment generated by processing a previous audio segment corresponding to the target audio segment using the student model; and
the previous audio segment and the target audio segment are both determined from same data, an arrangement position of the previous audio segment in the same data is adjacent to that of the target audio segment in the same data, and the arrangement position of the previous audio segment in the same data is earlier than that of the target audio segment in the same data.

15. The method according to claim 13, wherein a number of noise prediction values among the plurality of noise prediction values is determined according to a number of data among the plurality of data; and
a number of learnable parameters among the plurality of learnable parameters is determined according to the number of noise prediction values among the plurality of noise prediction values.

16. The method according to claim 13, wherein the plurality of data comprises first data and second data;
the plurality of noise prediction values comprise a first prediction value, a second prediction value and a third prediction value;
the first prediction value is a noise prediction value obtained by not introducing any condition into the denoising net of the teacher model;
the second prediction value is a noise prediction value obtained by introducing the first data into the denoising net of the teacher model as a condition; and
the third prediction value is a noise prediction value obtained by introducing both the first data and the second data into the denoising net of the teacher model as a condition.

17. An electronic device, comprising: a processor and a memory;
wherein the memory is used to store instructions or computer programs; and
the processor is used to execute the instructions or computer programs in the memory, so as to cause the electronic device to perform a model training method comprising:
obtaining sample data and noisy data corresponding to the sample data, wherein the sample data comprises a plurality of data, and different data among the plurality of data indicate different image generation conditions;
performing first processing according to a teacher model, the sample data and the noisy data to obtain a first prediction noise, and performing second processing according to a student model, the sample data and the noisy data to obtain a second prediction noise, wherein the first processing comprises denoising the noisy data using a denoising net of the teacher model to obtain a plurality of noise prediction values, different noise prediction values are obtained by introducing the different image generation conditions into the denoising net of the teacher model, and the first processing further comprises fusing the plurality of noise prediction values to obtain the first prediction noise; the second processing comprises introducing both the sample data and data obtained by fusing a plurality of learnable parameters into a denoising net of the student model as a condition, and the second processing also comprises denoising the noisy data using the denoising net of the student model to obtain the second prediction noise, and generation processing realized using the student model comprises part or all of the second processing; and
updating the student model and the plurality of learnable parameters according to a difference between the first prediction noise and the second prediction noise.

18. The electronic device according to claim 17, wherein a number of noise prediction values among the plurality of noise prediction values is determined according to a number of data among the plurality of data; and
a number of learnable parameters among the plurality of learnable parameters is determined according to the number of noise prediction values among the plurality of noise prediction values.

19. The electronic device according to claim 17, wherein the plurality of data comprises first data and second data;
the plurality of noise prediction values comprise a first prediction value, a second prediction value and a third prediction value;
the first prediction value is a noise prediction value obtained by not introducing any condition into the denoising net of the teacher model;
the second prediction value is a noise prediction value obtained by introducing the first data into the denoising net of the teacher model as a condition; and
the third prediction value is a noise prediction value obtained by introducing both the first data and the second data into the denoising net of the teacher model as a condition.

20. The electronic device according to claim 19, wherein the fusing the plurality of noise prediction values comprises:
performing weighted summation on a difference between the third prediction value and the second prediction value, a difference between the second prediction value and the first prediction value, and the first prediction value.
